(19) United States
(12) Patent Application Publication
(10) Pub. No.: US 2009/0106513 A1
(43) Pub. Date: Apr. 23, 2009

(54) Method for copying data in non-volatile memory system

(76) Inventors: Chuang Cheng, Hsinchu (TW); Chih-Wei Tsai, Hsinchu (TW); Shih-Chieh Tai, Hsinchu (TW); Satoshi Sugawa, Hsinchu (TW); Wen-Lin Cheng, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/875,952

(22) Filed: Oct. 22, 2007

(51) Int. Cl. G06F 12/00

(52) U.S. Cl. 711/162; 711/E12.001

(57) ABSTRACT

A method for copying data in a non-volatile memory system is disclosed. The method includes calculating a number of errors of a first set of data from a source block of the non-volatile memory saved in the buffer of the controller, transmitting the first set of data saved in the buffer of the controller to a buffer of the non-volatile memory when the number of errors is lower than a threshold, and programming a destination block of the non-volatile memory with the first set of data saved in the buffer of the non-volatile memory when the number of errors is lower than the threshold.

### BACKGROUND OF THE INVENTION

1. Field of the Invention

The present invention provides a method for copying data in a non-volatile memory system, and more particularly, a method for copying data in a non-volatile memory system with selective data correction.

2. Description of the Prior Art

A conventional non-volatile memory system comprises a controller and non-volatile memories. And the non-volatile memory system can be a flash memory system so that the flash memory system comprises a flash controller X and a flash memory Y. The flash controller X comprises an internal buffer W. The flash memory Y comprises an internal buffer Z. When the controller X copies data of a block A of the flash memory Y to another block B, the flash controller X has to do data correction on each page of the data stored in the block A, and then transmits the corrected data to the block B.

The above-mentioned data copying is generally used when data of a block of the flash memory is amended. When a part of data of a block (such as a block A) needs to be amended, the flash memory controller X locates a new block (such as a block B) of the flash memory Y for inputting a part of data which needs to be amended, and then copy the data from the old block A, that need not be amended, into the new block B to complete the data amendment.

Please refer to FIG. 1. FIG. 1 is a flowchart illustrating a conventional method 100 for copying data of the flash memory system without using copy-back function (meaning the flash memory Y does not support copy-back command function or flash memory Y supports copy-back function, but doesn't use it). For brevity, it is assumed that the source of data is the block A, and the destination of data is the block B. The steps of the method 100 are described as follows:

Step 101: Start;

Step 102: The controller X uses read command to load data from the block A to the buffer Z;

Step 103: The data saved in the buffer Z is transmitted to the buffer W;

Step 104: The controller X determines if the data saved in the buffer W is correct; if yes, go to step 106; if not; go to step 105;

Step 105: The controller X corrects the data saved in the buffer W from the step 103;

Step 106: The controller transmits the corrected data in the buffer W to the buffer Z;

Step 107: The controller X programs the data saved in the buffer Z to the block B;

Step 108: End.

The controller X repeats steps 102˜107 until all the pages of the block A are checked by the error correction code module (ECC module) and copied to the block B.

In step 105, the data correction process comprises 3 steps: A. Calculate the number of errors, B. Calculate the location and value of the errors, and C. Correct the data in the buffer W of the controller X according to the result of step B.

Please refer to FIG. 2. FIG. 2 is a flowchart illustrating a conventional method 200 for copying data of the flash memory system using copy-back function (meaning the flash memory Y supports copy-back command function and copy-back command is used). For brevity, it is assumed that the source of data is the block A, and the destination of data is the block B. The steps of the method 200 are described as follows:

Step 201: Start;

Step 202: The controller X uses copy-back read command to load data from the block A to the buffer Z;

Step 203: The data saved in the buffer Z is transmitted to the buffer W;

Step 204: The controller X determines if the data saved in the buffer W is correct; if yes, go to step 207; if not; go to step 205;

Step 205: The controller X corrects the data saved in the buffer W from the step 203;

Step 206: The controller X transmits the data in the buffer W to the buffer Z;

Step 207: The controller X programs the data saved in the buffer Z to the block B;

Step 208: End.

The controller X repeats Steps 202˜207 until all the pages of the block A are checked by the error correction code module (ECC module) and copied to the block B.

In step 205, the data correction process comprises 3 steps: A. Calculate the number of errors, B. Calculate the location and value of the errors, and C. Correct the data in the buffer of the controller X according to the result of step B.

In detail, in the method 100 and 200, assuming each block comprises 64 pages, when the controller X copies data of the block A to the block B, the controller X has to program the flash memory for 64 times. Furthermore, if there are errors within the data, the controller X needs to correct the errors and re-input the corrected data into flash memory for program which is time-consuming and will decrease the performance of flash memory system.

### SUMMARY OF THE INVENTION

The present invention provides a method for copying data in a non-volatile memory system. The non-volatile memory system comprises a controller and a non-volatile memory. The method comprises calculating a number of errors of a first set of data from a source block of the non-volatile memory saved in the buffer of the controller, transmitting the first set of data saved in the buffer of the controller to a buffer of the non-volatile memory when the number of errors is lower than a threshold, and programming a destination block of the non-volatile memory with the first set of data saved in the buffer of the non-volatile memory when the number of errors is lower than the threshold.

The present invention further provides a method for copying data in a non-volatile memory system. The non-volatile memory system comprises a controller and a non-volatile memory. The non-volatile memory supports copy-back function. The method comprises calculating a number of errors, error locations, and error values of a first set of data from a source block of the non-volatile memory saved in the buffer of the controller, correcting the first set of data saved in the buffer of the controller, and programming a destination block of the non-volatile memory with the first set of data saved in a buffer of the non-volatile memory when the number of errors is lower than a threshold.

The present invention further provides a method for copying data in a non-volatile memory system. The non-volatile memory system comprises a controller and a non-volatile memory. The non-volatile memory supports copy-back function. The method comprises calculating a number of errors of a first set of data from a source block of the non-volatile memory saved in the buffer of the controller, and programming a destination block of the non-volatile memory with the first set of data saved in a buffer of the non-volatile memory when the number of errors is lower than a threshold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a conventional method for copying data of the flash memory system without copy-back function.

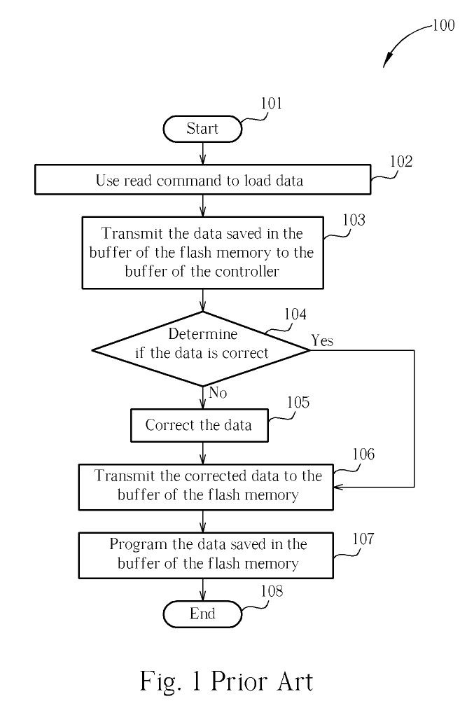

FIG. 2 is a flowchart illustrating a conventional method for copying data of the flash memory system with copy-back function.

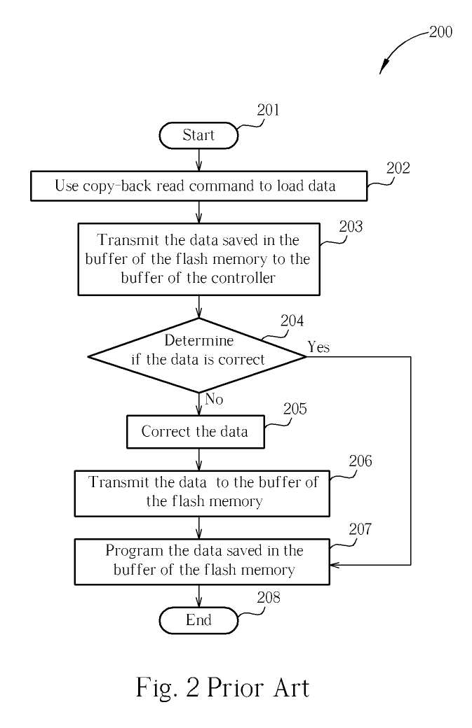

FIG. 3 is a flowchart illustrating a method for copying data of the flash memory system without copy-back function according to a first embodiment of the present invention.

FIG. 4 is a flowchart illustrating a method for copying data of the flash memory system with copy-back function according to a second embodiment of the present invention.

FIG. 5 is a flowchart illustrating a method for copying data of the flash memory system with copy-back function according to a third embodiment of the present invention.

### DETAILED DESCRIPTION

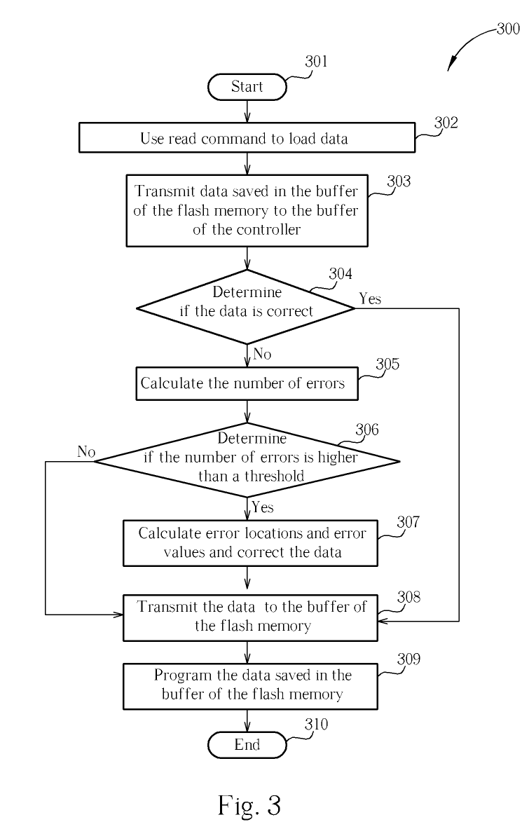

Please refer to FIG. 3. FIG. 3 is a flowchart illustrating a method 300 for copying data of the flash memory system without using copy-back function according to a first embodiment of the present invention. For brevity, it is assumed that the source of data is the block A, and the destination of data is the block B. The steps of the method 300 are described as follows:

Step 301: Start;

Step 302: The controller X uses read command to load data from the block A to the buffer Z;

Step 303: The data saved in the buffer Z is transmitted to the buffer W;

Step 304: The controller X determines if the data saved in the buffer W is correct (from step 303); if yes, go to step 308; if no, go to step 305;

Step 305: The controller X calculates the number of errors N;

Step 306: The controller X determines if the number N is higher than a threshold Nt; if yes, go to step 307; if not, go to step 308;

Step 307: The controller X calculates error locations and error values and correct the data saved in the buffer W;

Step 308: The controller X transmits the data saved in the buffer W to the buffer Z;

Step 309: The controller X program the data saved in the buffer Z to the block B;

Step 310: End.

The method 300 is only described with the copying steps for one page and the entire copy function for the block A to B is accomplished with repeating the method 300.

In the method 300, when the number N of errors of the data is lower than the threshold Nt, the controller X does not have to calculate error location, error value, correct data (in step 307). And the data only has to be proceeded with data correction (in step 307) when the number N of error of the data is higher than the threshold Nt. Therefore, the steps 307 does not have to be executed each time. According to the prior art, the steps 307 cost the most working cycles. Therefore, the method 300 of the present invention reduces the entire working cycles of the copy function of the flash memory system, increasing the efficiency of the flash memory system.

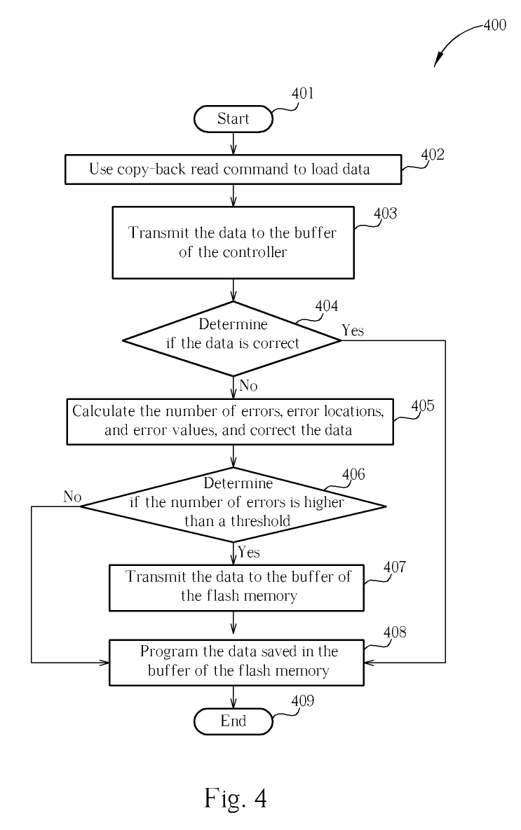

Please refer to FIG. 4. FIG. 4 is a flowchart illustrating a method 400 for copying data of the non-volatile memory system using copy-back function according to a second embodiment of the present invention. For brevity, it is assumed that the source of data is the block A, and the destination of data is the block B. The steps of the method 400 are described as follows:

Step 401: Start;

Step 402: The controller X uses copy-back read command to load data from the block A to the buffer Z;

Step 403: The data saved in the buffer Z is transmitted to the buffer W;

Step 404: The controller X determines if the data saved in the buffer W is correct (from step 403); if yes, go to step 408; if no, go to step 405;

Step 405: The controller X calculates the number of errors N, error locations, and error values, and corrects the data saved in the buffer W;

Step 406: The controller X determines if the number N is higher than a threshold Nt; if yes, go to step 407; if not, go to step 408;

Step 407: The controller X transmits the data saved in the buffer W to the buffer Z;

Step 408: The controller X programs the data saved in the buffer Z to the block B;

Step 409: End.

The method 400 is only described with the copying steps for one page and the entire copy function for the block A to B is accomplished with repeating the method 400.

In the method 400, when the number N of errors of the data is lower than the threshold Nt, the step 407 can be skipped. Therefore, the step 407 does not have to be executed each time. Therefore, the method 400 of the present invention reduces the entire working cycles of the copy function of the flash memory system, increasing the efficiency of the flash memory system.

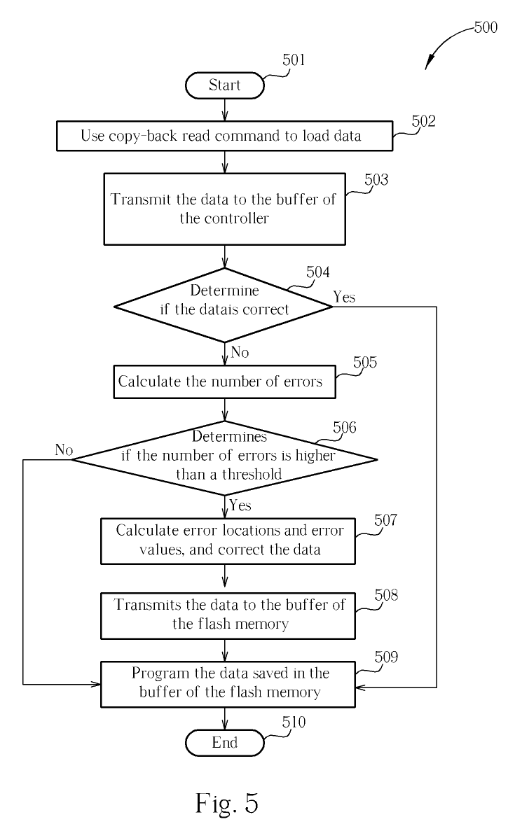

Please refer to FIG. 5. FIG. 5 is a flowchart illustrating a method 500 for copying data of the non-volatile memory system using copy-back function according to a third embodiment of the present invention. For brevity, it is assumed that the source of data is the block A, and the destination of data is the block B. The steps of the method 500 are described as follows:

Step 501: Start;

Step 502: The controller X uses copy-back read command to load data from the block A to the buffer Z;

Step 503: The data saved in the buffer Z is transmitted to the buffer W;

Step 504: The controller X determines if the data saved in the buffer W is correct (from step 503); if yes, go to step 509; if no, go to step 505;

Step 505: The controller X calculates the number of errors N;

Step 506: The controller X determines if the number N is higher than a threshold Nt; if yes, go to step 507; if not, go to step 509;

Step 507: The controller X calculates error locations and error values, and corrects the data saved in the buffer W;

Step 508: The controller X transmits the data saved in the buffer W to the buffer Z;

Step 509: The controller X programs the data saved in the buffer Z to the block B;

Step 510: End.

The method 500 is only described with the copying steps for one page and the entire copy function for the block A to B is accomplished with repeating the method 500.

In the method 500, when the number N of errors of the data is lower than the threshold Nt, the controller X does not have to calculate error location, error value, correct data (in step 507). And the data only has to be proceeded with data correction (in step 507) and to be transmitted from the buffer W to the buffer Z when the number N of error of the data is higher than the threshold Nt. In other words, the steps 507 and 508 can be skipped when the number N of errors of the data is lower than the threshold Nt. Therefore, the steps 507 and 508 do not have to be executed each time. According to the prior art, the steps 507 cost the most working cycles. Therefore, the method 500 of the present invention reduces the entire working cycles of the copy function of the flash memory system, increasing the efficiency of the flash memory system.

Those skilled in the art will readily observe that numerous modifications and alterations of the device and method may be made while retaining the teachings of the invention.

What is claimed is:

1. A method for copying data in a non-volatile memory system, the non-volatile memory system comprising a controller and a non-volatile memory, the method comprising:
calculating a number of errors of a first set of data from a source block of the non-volatile memory saved in the buffer of the controller;
transmitting the first set of data saved in the buffer of the controller to a buffer of the non-volatile memory when the number of errors is lower than a threshold; and
programming a destination block of the non-volatile memory with the first set of data saved in the buffer of the non-volatile memory when the number of errors is lower than the threshold.

2. The method of claim 1 further comprising:
loading the first set of data from the source block to the buffer of the non-volatile memory; and
transmitting the first set of data saved in the buffer of the non-volatile memory to the buffer of the controller.

3. The method of claim 1 further comprising:
calculating error locations and error values of the first set of data when the number of errors is higher than the threshold; and
correcting the first set of data when the number of errors is higher than the threshold;
transmitting the corrected first set of data saved in the buffer of the controller to a buffer of the non-volatile memory when the number of errors is higher than the threshold; and
programming the destination block of the non-volatile memory with the corrected first set of data saved in the buffer of the non-volatile memory when the number of errors is higher than the threshold.

4. A method for copying data in a non-volatile memory system, the non-volatile memory system comprising a controller and a non-volatile memory, the non-volatile memory supporting copy-back function, the method comprising:
calculating a number of errors, error locations, and error values of a first set of data from a source block of the non-volatile memory saved in the buffer of the controller;
correcting the first set of data saved in the buffer of the controller; and
programming a destination block of the non-volatile memory with the first set of data saved in a buffer of the non-volatile memory when the number of errors is lower than a threshold.

5. The method of claim 4 further comprising:
transmitting the corrected first set of data saved in the buffer of the controller to the buffer of the non-volatile memory when the number of errors is higher than the threshold; and
programming the destination block of the non-volatile memory with the corrected first set of data saved in the buffer of the non-volatile memory when the number of errors is higher than the threshold.

6. The method of claim 4 further comprising:
loading the first set of data from the first block to the buffer of the non-volatile memory; and
transmitting the first set of data saved in the buffer of the non-volatile memory to the buffer of the controller.

7. A method for copying data in a non-volatile memory system, the non-volatile memory system comprising a controller and a non-volatile memory, the non-volatile memory supporting copy-back function, the method comprising:
calculating a number of errors of a first set of data from a source block of the non-volatile memory saved in the buffer of the controller; and
programming a destination block of the non-volatile memory with the first set of data saved in a buffer of the non-volatile memory when the number of errors is lower than a threshold.

8. The method of claim 7 further comprising:
loading the first set of data from the source block to the buffer of the non-volatile memory; and
transmitting the first set of data saved in the buffer of the non-volatile memory to the buffer of the controller.

9. The method of claim 7 further comprising:
calculating error locations and error values of the first set of data when the number of errors is higher than the threshold;
correcting the first set of data when the number of errors is higher than the threshold;
transmitting the corrected first set of data saved in the buffer of the controller to the buffer of the non-volatile memory when the number of errors is higher than the threshold; and
programming the destination block of the non-volatile memory with the corrected first set of data saved in the buffer of the non-volatile memory when the number of errors is higher than the threshold.
